(19) United States
(12) Patent Application Publication
(10) Pub. No.: US 2024/0286441 A1
(43) Pub. Date: Aug. 29, 2024

(54) DATA DRIVEN SMART NON-PNEUMATIC TIRES

(71) Applicant: VIRGINIA TECH INTELLECTUAL PROPERTIES, INC., Blacksburg, VA (US)

(72) Inventors: UTKARSH GUPTA, Blacksburg, VA (US); RAJVARDHAN NALAWADE, Blacksburg, VA (US); SAIED TAHERI, Blacksburg, VA (US)

(21) Appl. No.: 18/563,246

(22) PCT Filed: Jun. 10, 2022
(86) PCT No.: PCT/US22/72876

§ 371 Date: Nov. 21, 2023

Related U.S. Application Data
(60) Provisional application No. 63/209,114, filed on Jun. 10, 2021.

(51) Int. Cl. B60C 23/06; B60C 7/14; G01M 17/02

(52) U.S. Cl. CPC B60C 23/062; B60C 7/146; G01M 17/025

(57) ABSTRACT

Various embodiments of a smart non-pneumatic tire and methods for generating a mean vibration characteristic of the smart non-pneumatic tire are described. In one embodiment, a method for measuring the mean vibration characteristic includes receiving tire-road contact acceleration data from an accelerometer that is secured near a tire-surface contact region, where the tire-road contact acceleration data includes data captured by the accelerometer over a duration of time while a tread along an outer periphery of a sector of the tire contacts a surface. The method further includes receiving velocity data for the tire and load data for the tire over the duration of time. The method further includes generating a mean vibration characteristic based on the above-mentioned data. The method also includes changing a stiffness of spokes of the tire based on the generated mean vibration characteristic in some cases.

### CROSS REFERENCE TO RELATED APPLICATIONS

This application claims the benefit of and priority to U.S. Provisional Application Ser. No. 63/209,114, filed Jun. 10, 2021, titled “DATA DRIVEN SMART NON-PNEUMATIC TIRES,” the entire contents of which are hereby incorporated herein by reference.

### BACKGROUND

Non-pneumatic tires, or airless tires, can provide safety from road hazards such as punctures, which can cause accidents due to tire blowouts. Typical non-pneumatic tires, however, can cause severe vibrations for the passenger. In addition, typical non-pneumatic tires may face issues of heat dissipation and ride discomfort caused by the severe vibrations. The minimal damping of vibrations achievable by current non-pneumatic tires hampers the commercial usability of non-pneumatic tires.

### SUMMARY

Various embodiments of a smart non-pneumatic tire and for generating a mean vibration characteristic for a non-pneumatic tire are described. In one embodiment, a method for measuring a vibration characteristic of the tire includes receiving, by a computing device, tire-road contact acceleration data from an accelerometer. The accelerometer can be secured to a spoke of a non-pneumatic tire within a sector of the tire, with the tire-road contact acceleration data including acceleration data captured by the accelerometer over a duration of time while a tread along an outer periphery of the sector of the tire contacts a surface. The method can also include receiving velocity data for the tire over the duration of time and normal load data for the tire over the duration of time. The method can further include generating a mean vibration characteristic for the tire based on the tire-road contact acceleration data, the velocity data, and the normal load data.

In various embodiments, the sector includes an area enclosed by a region of the tire, which can be defined as an area between a central angle, two radii, and a circular arc. The central angle (known as contact patch angle) can further be defined as an angle that is formed by an apex (vertex) at the center of the tire, and whose sides are the radii extending from the vertex to two distinct points on a circumference of the tire. A contact patch can include a portion of the tread of the tire along the circular arc that may contact a surface during rotation of the tire.

In one example, the method for measuring a vibration characteristic of the tire can involve chopping dynamic tire data, which can include the tire-road contact acceleration data, the velocity data, and the tire normal load data, into a plurality of per-revolution data subsets, with a per-revolution data subset including dynamic tire data for one revolution of the tire. In another example, the method can include generating a transfer function or a frequency response function for the tire based on the mean vibration characteristic for the tire over the duration of time. In another example, the method can include removing outlier data from the plurality of per-revolution data subsets and also feeding the plurality of per-revolution data subsets into a vibration modeler.

In some embodiments, the smart tire may include a second accelerometer secured to a center piece member of the non-pneumatic tire. The second accelerometer may be secured at a location closer to the center of the tire than to the accelerometer positioned on the spoke of the tire. The second accelerometer can be configured to transmit tire-center acceleration data to the computing device over the duration of time while the tread along the outer periphery of the sector of the tire contacts the surface. The mean vibration characteristic for the tire can be compared to the tire-center acceleration data for assessing the damping characteristics offered by the spoke structure.

In another example, generating the mean vibration characteristic for the tire can include applying a machine learning algorithm to the tire-road contact acceleration data, the velocity data, and the normal load data. The machine learning algorithm can include the use of a decision tree, bootstrapped aggregation, and/or a neural network. In some embodiments, predicting the mean vibration characteristic for the tire comprises performing a frequency domain analysis on the tire-road contact acceleration data, the velocity data, and the normal load data.

In various embodiments, the tire can include spokes that include smart material, which include material that can change in stiffness based on an external stimuli. In one example, the smart material can include piezoelectric material. Based on the generated mean vibration characteristic, the stiffness of the spokes can be changed in real-time.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a motor vehicle with a smart non-pneumatic tire implementation according to various embodiments described herein.

FIG. 2 illustrates an example of the smart non-pneumatic tire shown in FIG. 1 according to various embodiments described herein.

FIG. 3 illustrates another example of the smart non-pneumatic tire shown in FIG. 1 according to various embodiments described herein.

FIGS. 4-7 illustrate data collected from various sensors of a test setup of a smart non-pneumatic tire implementation according to various embodiments described herein.

FIG. 8 illustrates a schematic block diagram that provides one example illustration of computing devices that are used in the smart tire implementations shown in FIGS. 1-3 according to various embodiments described herein.

FIG. 9 is a flowchart illustrating one example of functionality implemented as portions of a control system executed in the computing devices of FIGS. 1-3 according to various embodiments described herein.

### DETAILED DESCRIPTION

Non-pneumatic tires, or puncture-free tires, provide a next-generation mobility solution for making rides safe from punctures and common road hazards, which often result in accidents due to tire blowouts. The absence of air in such tires, however, can toggle a negative effect which can affect ride comfort, as the air in a regular pneumatic tire serves to dampen such vibrations. Thus, the commercial usability of conventional non-pneumatic tires is hampered by inherent problems like heat dissipation and ride discomfort.

In order to address the shortcomings and ride discomfort challenges faced by non-pneumatic tires today, the present disclosure presents a smart non-pneumatic tire that can use real-time vibration information to alter the framework of such tires. Such tires can sense the road profile and control the stiffness of the structural aspects of the tire-spoke framework to stiffen or dampen them based on driving conditions. In addition, the tire-spoke framework may be altered based on information about instantaneous road profiles and ride quality metrics. Accordingly, the smart non-pneumatic tires described herein can address not only tire blowouts but also provide a softer ride using a feedback control system.

In the context outlined above, various embodiments of a smart non-pneumatic tire and methods for generating a mean vibration characteristic of the smart tire are described herein. In various embodiments, generating a mean vibration characteristic can include predicting a mean vibration characteristic. In one embodiment, a method for measuring the mean vibration characteristic includes receiving tire-road contact acceleration data from an accelerometer that is secured to a spoke of the non-pneumatic tire within a sector of the tire, where the tire-road contact acceleration data includes data captured by the accelerometer over a duration of time while a tread extending along an outer periphery of the sector contacts a surface. The method further includes receiving velocity data for the tire and load data for the tire over the duration of time from the accelerometer secured to a spoke of the tire. In one example, the velocity data and the load data for the tire may be received by extracting or retrieving the data from the accelerometer secured to the spoke of the tire. The method further includes predicting a mean vibration characteristic based on the above-mentioned data. The method also includes changing a stiffness of the spokes of the tire based on the predicted mean vibration characteristic in some cases.

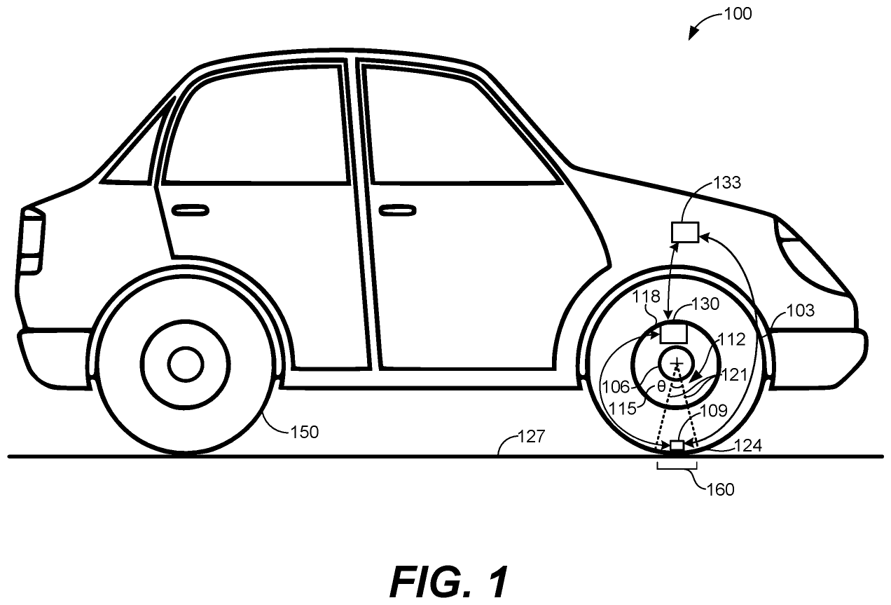

With reference to the drawings, FIG. 1 illustrates a motor vehicle 100 with smart non-pneumatic tires 103 and 150 implemented according to various embodiments described herein. The smart tires 103 and 150 can measure vibration characteristics of the road and change the stiffness of spokes within the smart tires 103 and 150 based on the measured vibration characteristics. The illustration in FIG. 1 is provided as a representative example. The motor vehicle 100, the smart tires 103 and 150, and other components shown in FIG. 1 are not necessarily drawn to any particular scale or size. Additionally, FIG. 1 is not exhaustively illustrated, meaning that other components that are not shown in FIG. 1 can be included and relied upon in some cases. Similarly, one or more of the components shown in FIG. 1 can be omitted in some cases.

Among other components, the motor vehicle 100 includes a computing device 133 and the smart tires 103 and 150. The smart tire 103 includes an accelerometer 109, a tire-center member 118, and a computing device 130, among possibly other components. The smart tire 150 can be similar to the smart tire 103. In other cases, the smart tire 150 can omit the accelerometer 109 and other components of the smart tire 103.

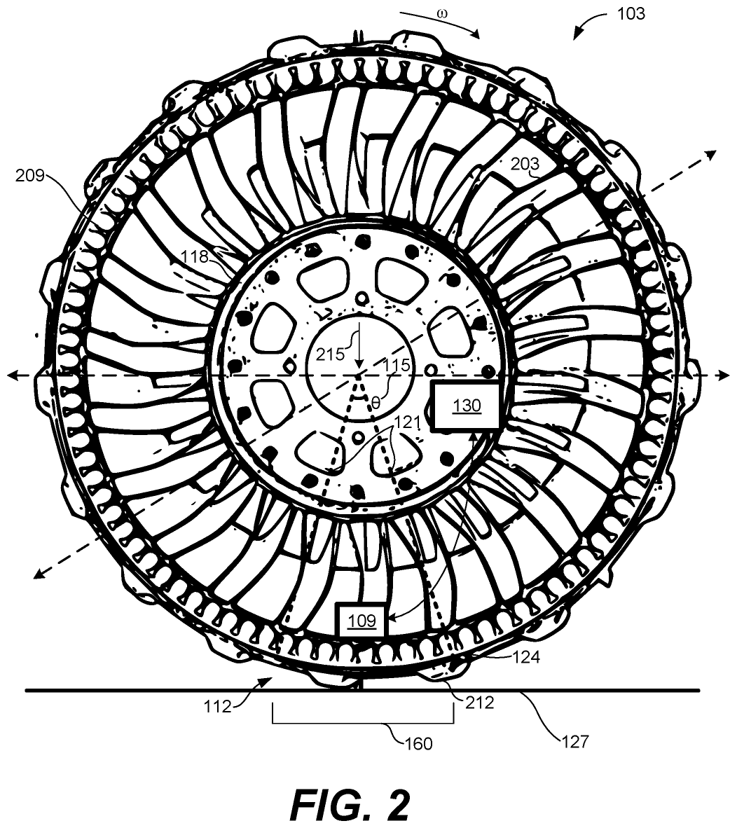

The accelerometer 109 is positioned within the smart tire 103 and can be attached to one or more spokes (see FIG. 2) of the non-pneumatic tire 103, at an intersection point between the spokes and tread of the tire 103, or at another suitable location in or on the non-pneumatic tire 103. In one example, the accelerometer 109 can be secured within a sector 112 of the tire 103 and can be configured to measure acceleration experienced by the tire 103 while the tire 103 contacts a surface 127 as the motor vehicle 100 is driven. In this regard, the surface 127 may be a road, pavement, or any surface a car may be moved or driven on, and the accelerometer 109 can include devices that can measure the vibration or acceleration of a motion of a structure.

The computing devices 130 and 133 can include one or more processing circuits, for example, having processors and memories or memory devices, which can be coupled to a local interface for data communications. The processing circuits of the computing devices 130 and 133 can process data, as described herein, such as dynamic tire data of the smart non-pneumatic tire 103, the tire 150, and other tires of the motor vehicle 100, including normal load data, velocity data, and tire-road contact acceleration data. The computing devices 130 and 133 can also include power sources, such as batteries or other power sources, and battery charging systems. The local interfaces of the computing devices 130 and 133 can be embodied as wired, wireless, or wired and wireless local interfaces.

The accelerometer 109 can be embodied as one or more accelerometers. As one example, the accelerometer 109 is capable of measuring acceleration (i.e., the rate of change of velocity) as compared to its own instantaneous rest frame and provide feedback signals or data representative of the acceleration. The accelerometer 109 can be a single- or multi-axis accelerometer, capable of detecting both the magnitude and the direction of the acceleration in some cases, as a vector quantity. In some cases, the accelerometer 109 can be an inertial measurement unit (IMU) capable of also measuring orientation, positional angular information, velocity, and other inertial information related to the tire 103. Thus, the accelerometer 109 can also sense orientation, coordinate acceleration, vibration, shock, and falling motions in some cases. The accelerometer 109 provides the feedback signals or data including these metrics to the computing device 130 for further processing, as described below. Based in part on the feedback signals from the accelerometer 109 and other data, the computing device 130 can calculate a mean vibration characteristic for the tire 103, among other characteristics, as described below. Examples of the accelerometer 109 can include accelerometers from Dytran®, Honeywell®, Bosch®, and other manufacturers.

The sector 112 is an area enclosed by a region of the tire 103, which can be defined as an area between a central angle (θ) 115, two radii 121, and a circular arc 124 between the two radii 121. According to various embodiments, the central angle (θ) can include a contact patch angle (θ). In this respect, the central angle (θ) 115 can further be defined as an angle that is formed by an apex (vertex) at the center of the tire 103 and/or the tire-center member 118, and whose sides are the radii 121 extending from the vertex to two distinct points on the circumference of the tire 103. In this respect, the circular arc 124 connects the radii 121 along the circumference of the tire 103. Although FIG. 1 illustrates one sector 112, more than one sector that includes an accelerometer may be implemented in the smart tire 103 in accordance with the various embodiments presented herein.

In the example shown, the accelerometer 109 is secured within the sector 112 at a location closer to the circular arc 124 than to the tire center member 118 of the tire 103. The accelerometer 109 can be secured close to the tread of the tire 103 that extends along the circular arc 124 on the inner liner of the tire. The tire 103 can experience vibrations coming from the tire-surface interface as a contact patch 160 comes into contact with the surface 127. As the contact patch 160 contacts the surface 127, vibration characteristics being transferred from the surface 127 to the smart tire 103 can be measured by the accelerometer 109. For example, when the motor vehicle 100 is being driven, the tread of the tire 103 that extends along the circular arc 124, to which the accelerometer 109 is positioned near, contacts the surface 127 for a short duration of time in each revolution of the tire 103. Accordingly, the accelerometer 109, when configured to measure acceleration, can measure vibrations transmitted from the surface 127 through the tire-surface contact patch 160 to the tire 103, and the motor vehicle 100.

The accelerometer 109 may be in data communications with the computing device 130, computing device 133, or both the computing devices 130 and 133. The network communications interfaces can include wireless communications interfaces, such as cellular, WI-FIR, BLUETOOTH®, Z-WAVER, ZigBee, or other wireless communications interfaces. In other examples, the network communications interfaces can include wired communication interfaces. The wired communications interfaces for the computing device 133 can also include Controller Area Network (CAN) interfaces, Media Oriented Systems Transport (MOST) interfaces, Local Interconnect Network (LIN) interfaces, Flexray® Automotive Communication interfaces, and other network communication interfaces and protocols. The computing devices 130 and 133 can retrieve and extract data from the accelerometer 109. Additionally, the computing devices 130 and 133 can store data from the accelerometer 109, process the data, and generate new data. In some embodiments, the computing devices 130 and 133 may supply power to the accelerometer 109. Additionally, the computing device 130 can be located within the tire 103 while the computing device 133 can be located in the vehicle 100 as part of an independent vehicle computer system.

Moving on to FIG. 2, shown is a side view of the smart non-pneumatic tire 103 according to one embodiment of the present disclosure. The smart tire 103 includes a number of spokes 203. The spokes 203 can be made out of various materials of varying stiffnesses. To this end, the spokes 203 can include smart material, such as piezoelectric material, shape memory materials, chromoactive materials, magnetorheological materials, photoactive materials, and other types of smart materials. Such smart materials have one or more properties that may be changed or controlled by external stimuli. The spokes 203 extend radially from the tire-center member 118 of the tire 103 to a tread 212 of the tire 103.

Also shown in FIG. 2 is the accelerometer 109 secured to one of the spokes 203. As explained with respect to FIG. 1, the accelerometer 109 can be positioned within the sector 112 near the vicinity of the tread 212 of the tire 103 that extends along the circular arc 124. As the tire 103 rotates with an angular velocity ω, the tread 212 of the tire 103 extending along the circular arc 124 may contact the surface 127 for a short duration for each tire revolution. The accelerometer 109 can be configured to send tire-road contact acceleration data to the computing device(s) 130 and/or 133 continuously or over a duration of time while the tread 212 of the tire 103 extending along the circular arc 124 contacts the surface 127. Accordingly, the duration of time can include multiple revolutions of the tire 103, and the accelerometer 109 may only capture the tire-road contact acceleration data for a specific duration of time for each tire revolution. Therefore, the computing device(s) 130 and/or 133 may store the tire-road contact acceleration data over multiple tire revolution data sets over a duration of time.

In addition, the computing devices 130 and 133 can be configured to receive velocity data for the tire 103 and normal load data for the tire 103 during movement. In various embodiments, the velocity data for the tire 103 may be extracted from the data measured by the accelerometer 109. In some embodiments, the velocity may be measured by the computing device 133, using alternate sensors like a global positioning system (GPS), or by a speedometer of the vehicle 100. In this respect, the velocity data received by the computing devices 130 and 133 may be an instantaneous velocity of the vehicle 100 or the tire's angular velocity (rotational velocity) @.

The normal load data can include data associated with the vertical load 215 of the motor vehicle 100, acting on a center of the tire 103. The vertical load 215 applied to the tire 103 may be dynamic or varying over time. The vertical load 215 may be measured by a load cell connected to the tire 103 or through other means such as using strain gages attached to the suspension system of the vehicle 100 as can be appreciated. The vertical load 215 may also be extracted from the data measured by the accelerometer 109 in some cases.

The computing device 130 can be configured to process the tire-road contact acceleration data, the velocity data, and the load data to generate a mean vibration characteristic of the tire 103. Alternatively, the computing device 133 can be configured to process the tire-road contact acceleration data, the velocity data, and the load data to generate a mean vibration characteristic of the tire 103. In some cases, the computing devices 130 and 133 can operate together to process the data and generate the mean vibration characteristic of the tire 103. The generated mean vibration characteristic is estimated at the center of the tire 103 during the movement of the vehicle 100. Based on the generated mean vibration characteristic and/or driving conditions, the computing device(s) 130 and/or 133 can change the stiffness of the spokes in real-time.

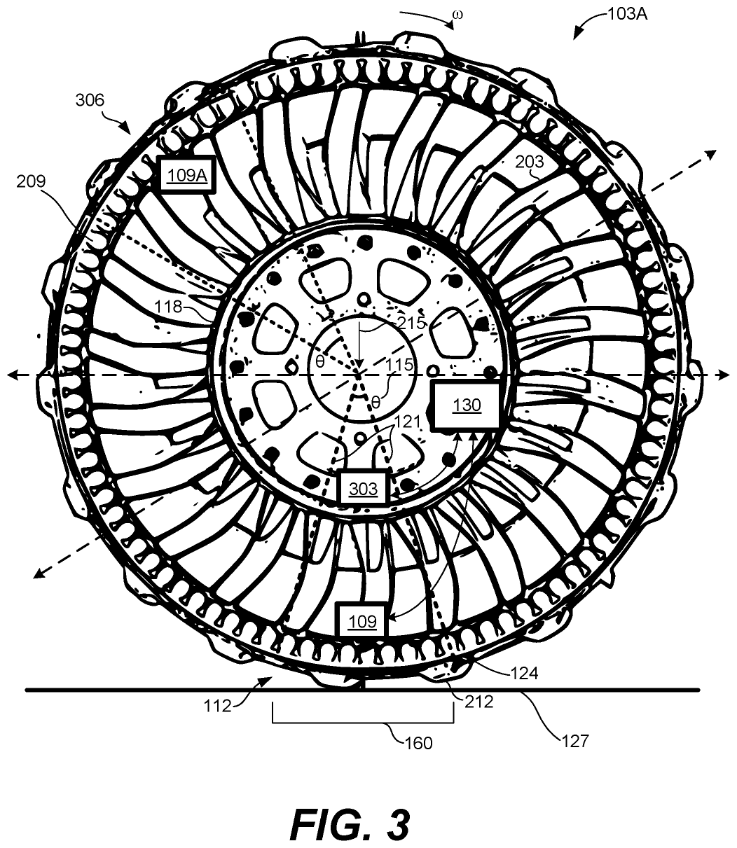

Referring to FIG. 3, shown is a side view of a smart tire 103A according to various embodiments of the present disclosure. The smart tire 103A includes an additional accelerometer 303 that can be attached at or near the center of the tire 103A, on the tire center member 118. In some embodiments, the additional accelerometer 303 may be attached as close to the tire center as possible. Alternatively, the accelerometer 303 can be attached to a hub 106 of the vehicle 100, on to which the tire 103 can be mounted, to measure the acceleration at the center of the tire 103. Specifically, the accelerometer 303 can be configured to transmit tire-center acceleration data to the computing device(s) 130 and/or 133 (FIG. 1).

In one example, the accelerometer 303 may transmit the tire-center acceleration data over the same duration of time while the accelerometer 109 transmits the tire-road contact acceleration data. That is, the accelerometer 303 can be configured to transmit the tire-center acceleration data during specific periods of time the tread 212 that extends along an outer periphery of the circular arc 124 contacts the surface 127. By implementing such a configuration, certain advantages may be achieved, such as reducing computer resources utilization (e.g., memory consumption, processor utilization, network transfer, etc.). In other embodiments, the accelerometer 303 may transmit tire-center acceleration data continuously.

In order to accurately measure vertical acceleration (z-axis), longitudinal acceleration (x-axis), and lateral acceleration (y-axis), at the center of the tire 103, the accelerometer 303 may be vertically aligned with the accelerometer 109. Accordingly, the data that is retrieved from the accelerometer 303 during periods of time the tread 212 that extends along an outer periphery of the circular arc 124 contacts the surface 127 represents vertical vibrations, or roughness of the ride, transmitted from the contact patch 160 to the center of the tire 103, or to the hub 106 of the vehicle 100.

According to various embodiments, the computing device(s) 130 and/or 133 can predict the mean vibration characteristic at the center of the tire 103 using the tire-road contact acceleration data, measured by the accelerometer 109, to determine the mean vibration characteristic transmitted from the road surface to the hub 106 of the vehicle 100. This predicted mean vibration characteristic can be compared with the tire-center acceleration data, measured by accelerometer 303, to determine its accuracy. If it is determined that the predicted mean vibration characteristic is accurate, the computing devices 130 and/or 133 may adjust the stiffness of the spokes 203 in some cases to improve the ride comfort if deemed necessary. If not deemed accurate, the computing devices 130 and/or 133 may continue to process the tire-road contact acceleration data, the load data for the tire 103A, and the velocity data for the tire 103A, for more per-revolution data sets until an accurate mean vibration characteristic is predicted. However, in some embodiments, the computing devices 130 and/or 133 may adjust the stiffness of the spokes 203 based on the predicted mean vibration characteristic regardless of the comparison with the tire-center acceleration data.

Apart from the accuracy of the predicted mean vibration characteristic, in some embodiments, the stiffness of the spokes 203 can be adjusted based on a manufacturer and/or user-defined ride comfort matrix. The predicted mean vibration characteristic can be compared against the defined ride comfort matrix and if the predicted mean vibration characteristic is higher than the maximum limit on this comfort matrix, the computing devices 130 and/or 133 can reduce the stiffness of the spokes 203 to dampen the vibrations. Alternatively, if the predicted mean vibration characteristic is lower than the minimum limit of the comfort matrix, the computing devices 130 and/or 133 can increase the stiffness of the spokes 203.

Also illustrated in FIG. 3 is a second sector 306. Included in the sector 306 can be another accelerometer 109A secured to one or more of the spokes 203 within the sector 306, incorporating all of the features discussed for the accelerometer 109. In this respect, the smart tire 103A can include any number of accelerometers positioned in any number of sectors and in data communication with the computing devices 130 and 133, in order to measure tire-road contact acceleration data. Therefore, the number of accelerometers or sectors in the smart tire 103 or 103A is not a limiting factor according to the embodiments of this disclosure.

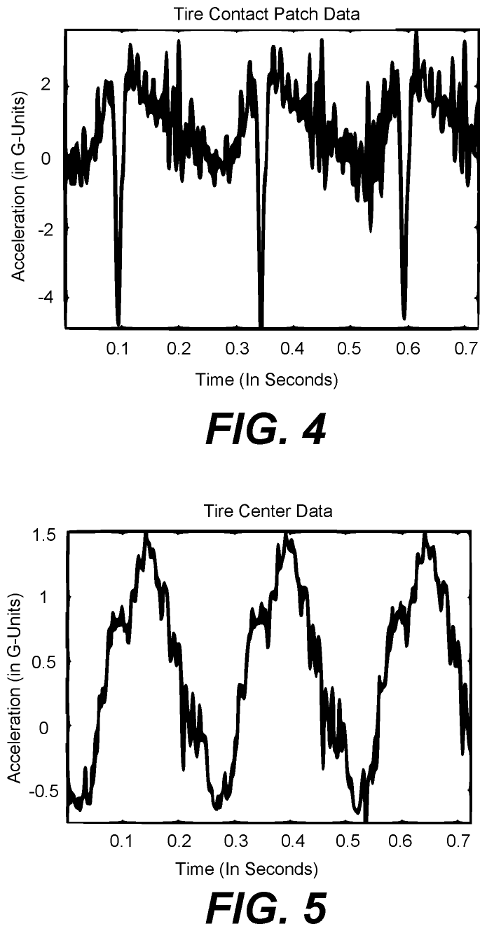

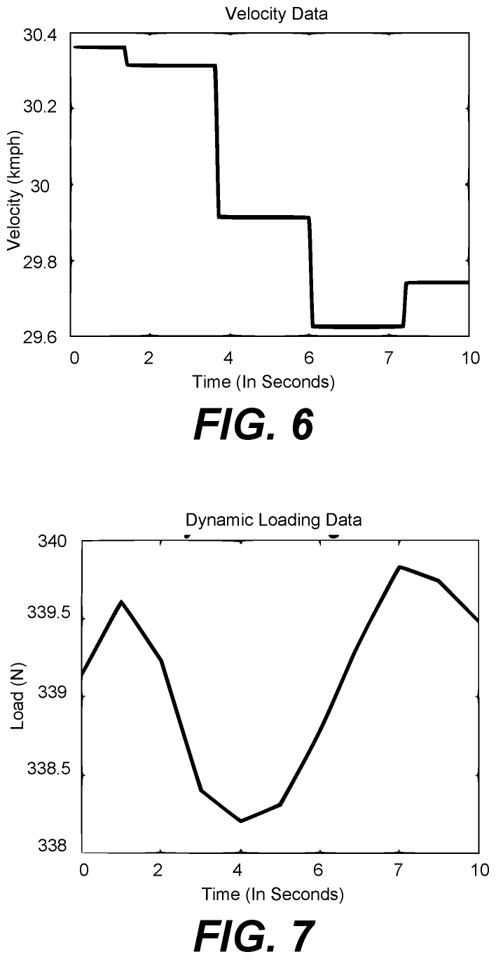

The following paragraphs describe a test setup conducted using the smart-tires described herein according to various embodiments. The data collected for an experiment includes data from indoor tests performed on a rolling resistance test rig. FIGS. 4-7 illustrate data collected from various sensors of the test setup of the smart tires according to various embodiments described herein. The items used during the testing include non-pneumatic tires, a data acquisition system, and a test-rig, etc. A rolling resistance test system from Test Measurement System International (TMSI) was redesigned to allow for force and moment testing of passenger car tires. This remodeled test rig was used in the form of an indoor test rig for this application. The test rig had a rolling drum of 1.7 m diameter and 0.3 m face width. The rig was powered by a 60 HP D.C. motor. The rolling drum and motor setup had the capability to roll at up to 100 kph. The D.C. motor was also equipped with an optical rotary encoder which was calibrated to have a precise measurement of the rolling speed of the drum.

The test rig had a P120 grit abrasive sanding cloth attached to the face of the drum. The cloth roll replicated an asphalt road surface. Multiple different grit sandpapers can be installed on the drum to allow for different friction surface availability. Apart from the capability of having multiple rolling speeds and friction surfaces, the rig also had the potential to add camber and slip to the tire tested. A load cell was also mounted on the rig to control the normal loading applied on the tires, both static and dynamic. The test rig was controlled via a computer system with proprietary software from TMSI installed on it. The software controls the speed of the test rig among other things. The specifications of this rig are stated in Table 2.1.

TABLE 2.1
Rolling Resistance Test Rig Specifications

| | | |
|---|---|---|
| Drum Diameter | 1.7 | m |
| Drum Face Width | 0.3 | m |
| Max Speed | 100 | kph |

| | |
|---|---|
| Loading Mechanism | Load Cell coupled with a |
| | Linear Motor Driven Bolt |
| Tire Sizes | 14″ to 18″ |
| Slip Angle Sweep | +−15° |
| Camber Angle Sweep | +−10° |
| Sanding Surface | P120, P80 |

The goal of the experiment was to understand the vibration characteristics transmitted through the non-pneumatic tires. The transmission of the vibrations being assessed was from the contact patch between these tires and the surface (in this case, the drum of the test rig), to the center of the non-pneumatic tires. The transmissibility is an effect of the spoke structure of the non-pneumatic tires. The transmissibility is affected by the design of the spoke structure and the stiffness of the materials used in the non-pneumatic tires. For the experiment, tests were conducted on two non-pneumatic tires with differences in the stiffness of the spoke materials. The basic design of the spoke structure was similar for both these tires. This difference in the stiffness of the spoke materials was assessed in the experiments.

The rolling resistance test rig was equipped with two sensors, including a load cell to measure the normal loading applied on the tires and an encoder to evaluate the rolling speed of the drum. Apart from these two sensors, two accelerometers were installed on the non-pneumatic tires along with a slip ring based wired connection to the data acquisition system. A brief overview of these sensors is discussed below. Two Dytran® 3343A3 tri-axis accelerometers were installed on the non-pneumatic tires for the experiment. The accelerometers were chosen due to their small size and low weight. These accelerometers were installed on the spoke structure of the tires such that one of the accelerometers was near the tire-surface contact region and the other one was near the center of the tire. Both the accelerometers were installed at a laterally centered location using cyanoacrylate glue.

The transmission of data from the accelerometers to the data acquisition system was through a wired setup involving a slip ring, a signal conditioner, and finally, a data acquisition device. The slip ring used for this application was a Michigan Scientific SR10A/PE512. A slip ring was used as it permits data transmission from a rotating body (the tires) to a stationary body (the data acquisition device) seamlessly. This slip ring was mounted onto the tires by an in-house adapter. These accelerometers required DC power for their usage. A signal conditioner (Dytran® Model 4116) was used in this setup to supply continuous regulated power to these accelerometers. This device ran on an A.C. line supply and had up to 16 connection channels.

The test rig used in the experiments has the capabilities to measure the normal load applied onto the tires. The load was applied by the use of a linear actuation system driven by a DC motor. The linear actuator had a bolt head as its pushing agent, which applies load onto the frame, which holds the tires. A load cell, from Sentran® PH Series, was attached to this linear actuator. The load cell had a rated capacity of 7.5 k lbs. The purpose of the load cell was to measure the amount of normal force applied to the tires by the linear actuator. The load cell was calibrated to map the tire force at the tire center while the tire was rolling with the drum surface. The load cell outputs the normal force constantly and, thus, the test rig had the ability to display and control the dynamic load applied on the tires.

The drum in the test rig was powered by a 60 HP DC motor. The motor actuated the rotary motion of the drum. The speed at which the drum was rotated was user-fed and was constant and controlled. Thus, a high-precision rotary optical encoder was mounted on the motor, which was calibrated to provide speed in “kph” units for the drum. The encoder, Model 725 by Accu-Coder, had a resolution of 1024 cycles per revolution making it very precise for this application.

For such data-driven approaches, there is a need for a good system to record the data from the sensors. For this instrumentation, Data Acquisition Systems (DAQs) by National Instrument (NI) were used along with the data logging capabilities of the computer system which controls the test rig. The computer system had a software interface that displays and records data, such as the rolling speed from the encoder, the ambient air temperature, the date and time of the tests, and possibly other data. Apart from the data recorded by the computer system, the additional sensors' data from the accelerometers and the load cell were recorded through a NI 6212 DAQ. This data was logged at a 9600 Hz sampling rate to help assess the high-frequency spectral content of the signals.

With the hardware setup in place, a thorough data bank was generated by varying the rolling speeds, applied normal load, and the use of two different airless tires. The test matrix for this experimentation is shown in Table 3.1.

TABLE 3.1
Test Matrix

| | | |
|---|---|---|
| Rolling Speeds | 30, 60 | km/h |
| Normal Load | 250, 500 | lbs |

| | |
|---|---|
| Tires Used | 2 non-pneumatic tires |

The data bank generated comprised of data from the two accelerometers, at the contact patch and at the tire center, dynamic normal load, and velocity. Sample data for all these 4 sensors is shown in FIGS. 4-7, which show data for multiple tire revolutions. This raw data collected using the hardware setup explain earlier needs of cleaning and pre-processing. The steps involved in such data-cleaning stages involve data chopping, outlier removal, and so on. These processes, followed by the signal processing techniques applied to these signals are elaborated in the subsections below.

The raw tire data recorded included data from multiple different tire revolutions. For this analysis, the data per tire revolution was assessed to identify some relevant information which these signals may hold. For this assessment, the raw tire data was be chopped and separated into single tire revolution data sets. Thus, a data chopping algorithm was applied to this data set and the output of this algorithm is separated tire data. Further, some tire revolutions did not conform to how a standard signal should look like. These “outliers” were then cleared from the data set.

In addition, the experiments used the information, which the tire sensor contained. This information can be accessed and processed by using either the time-domain representation or the frequency-domain spectral content of the data. The spectral content method was followed for one analysis, as it decomposes the time-varying signals into their frequency composition, although the time-domain representation can be relied upon. Welch's periodogram method was utilized for accessing the spectral domain information for the tire sensor data sets in one case.

One goal of the experiment was to estimate the mean vibration content captured by the tire center accelerometer using the tire-road contact acceleration data from the tire-road contact patch. This approach provides an understanding of the ride roughness based on contact patch vibrations. In addition to this, spoke designs can be altered based on the tire-road contact acceleration data and the estimates of tire vibrations to ensure a smoother ride.

During experimentation, the tire-road contact accelerometer data was compared for the two types of non-pneumatic tires. A distinction was observed between the data collected for the two tires with varying stiffness. The distinction held for both the contact patch and tire-center/spindle accelerometer data sets. Thus, certain signal features like maximum peak height, and contact patch length were observed to be sensitive to changes in tire stiffness. Based on conclusions from previous work, it was known that both the tire center data and the tire contact acceleration data were affected by dynamic loading and instantaneous velocity.

Therefore, four features, including contact patch length, maximum peak height, dynamic loading, and velocity were selected as input features. The estimation target was the mean vibration characteristics for the tire center for one tire revolution. This vibration data at the tire center was accessed when the contact-patch accelerometer was in the vicinity of tire-ground contact. This location ensured that the z-axis of the tire-center accelerometer was aligned in the vertical direction when the contact-patch accelerometer was near contact. Thus, with these spatial limits, the mean tire center acceleration estimated using this approach represented vertical vibrations or the roughness of the ride.

With this information, a machine learning environment was set up with four features as input, including the contact patch length, maximum peak height, dynamic loading, and velocity, and one output, the mean vertical vibration at the tire center. Bagged decision trees were chosen as the classical machine learning algorithm for solving the estimation problem. The algorithm used for this experiment was a combination of decision trees and bootstrapped aggregation (bagging).

Decision trees are a simple if-else-based machine learning technique that breaks down the data set into logical regions. The decision trees start with a root node and, following the root node, an if-else question is asked, which divides the data set into two sections called leaf nodes. Successive if-else questions are asked and the entire data set is divided into such sections such that no further division is possible. This splitting of the region is stopped when the L2-norm error starts increasing on adding a split.

A bootstrapped aggregation method has also been deployed on top of this decision trees model, thus transforming the method into a random forest algorithm. Bootstrapped aggregation includes picking random sub-samples of the data and training several regressors on these small batches of data. The random sub-samples chosen from the data set have the same statistical features as the parent data, thus exposing the regressors to data in different subsets having similar statistical attributes. The predictions of all these regressors were averaged and the final prediction was calculated. This process helped in reducing the variance of the output of machine learning. Hence, the bagging approach was chosen for this experiment, although other approaches can be relied upon according to the embodiments. The developed model was trained on 70% of the data with 15% reserved for five-fold cross-validation and 15% held back for test data. An R² of 0.86 was achieved, and a normalized mean absolute error of 18% was observed on the test data set. The results achieved with the approach were promising for a classical machine learning-based approach.

For the assessment of the vibrational characteristics of the tires, a machine learning model was also developed for the experiment to estimate tire center vibrations of a non-pneumatic tire using the tire-road contact acceleration data. The developed machine learning algorithms use classical bagged trees for this estimation problem, and the input features were extracted from the time domain. In addition, frequency domain features may be looked at, and neural networks may be used as the machine learning techniques. This would enable covering maximum variance in the data set, thus increasing the R² and minimizing the error.

In addition, a transfer function or a frequency response function can be generated with the tire-road contact acceleration data as the input and tire center acceleration data as the output of the transfer function. The transfer function or a frequency response function can help in the creation of new designs, given a particular spoke design and material stiffness. Based on different spoke designs and materials, different transfer functions can be obtained for the two sets of data. This transfer function or frequency response function can also serve as an industrial test bench to assess the damping characteristics of the non-pneumatic tires with different spoke structures and material stiffnesses, computationally bypassing the need to physically build and test the tire. The generated transfer functions can be employed in the utility of smart materials as spoke material, such that the materials can change their stiffness or the transfer function to get an apt response at the tire center to ensure a smoother ride.

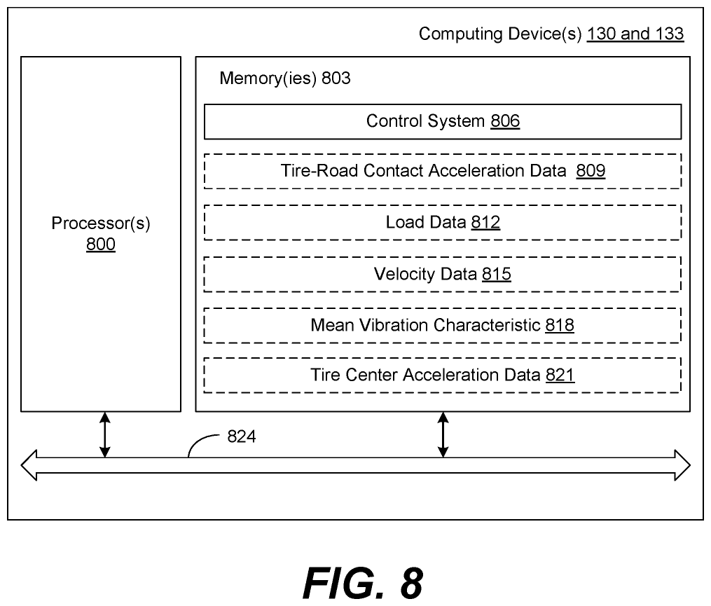

Referring now to FIG. 8, shown is a schematic block diagram of the computing devices 130 and 133. Each of the computing devices 130 and 133 includes at least one processor circuit, for example, having a processor 800 and a memory 803, both of which are coupled to a local interface 824. To this end, each of the computing devices 130 and 133 may comprise, for example, at least one computer, processing circuit, or like device. The local interface 824 may comprise, for example, a data bus with an accompanying address/control bus or other bus structure as can be appreciated, in either wired or wireless form.

Stored in the memory 803 are both data and several components that are executable by the processor 800. In particular, stored in the memory 803 and executable by the processor 800 are a control system 806 and potentially other applications. Also stored in the memory 803 are tire-road contact acceleration data 809, load data 812, velocity data 815, which are gathered by the sensors described herein. Also stored in the memory 803 are a mean vibration characteristic 818 and tire center acceleration data 821, with each of these being processed or otherwise generated by the control system 806.

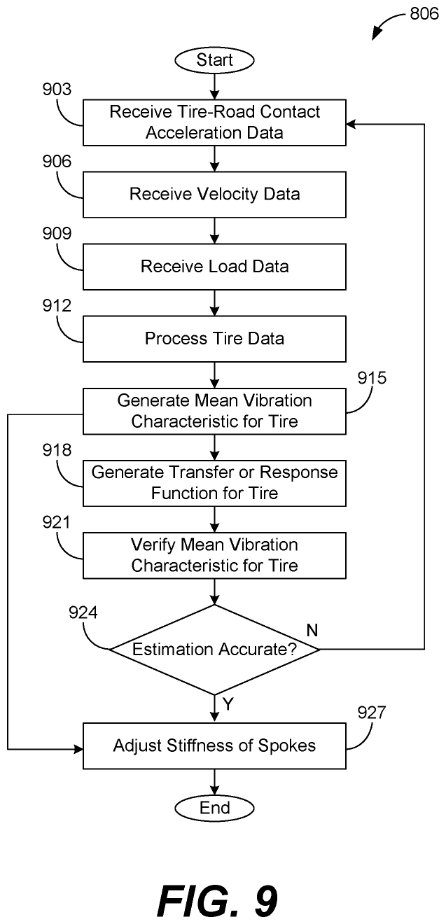

Referring next to FIG. 9, shown is a flowchart that provides one example of the operation of a portion of the control system 806 according to various embodiments. It is understood that the flowchart of FIG. 9 provides merely an example of the many different types of functional arrangements that may be employed to implement the operation of the portion of the control system 806 as described herein. As an alternative, the flowchart of FIG. 9 may be viewed as depicting an example of elements of a method implemented in the computing devices 130 and 133 (FIG. 1) according to one or more embodiments.

Beginning with box 903, the computing devices 130 and 133 can be configured to receive the tire-road contact acceleration data 809 from the accelerometer 109. In one example, receiving the tire-road contact acceleration data 809 includes extracting or retrieving the data 809 from the accelerometer 109. As described with respect to FIGS. 1-3, the accelerometer 109 can be secured to one or more of the spokes 203 (FIGS. 2 and 3) within the sector 112 of the tires 103 or 103A, and within close proximity of the tread 212 extending along the circular arc 124 of the tires 103 or 103A (FIGS. 1-3). This close placement to the tread 212 extending along the circular arc 124 enables the accelerometer 109 to measure the vibrations transmitted from the surface 127 (FIGS. 1-3) to the contact patch 160, and to the center of the tires 103 or 103A.

In various embodiments, the computing devices 130 and 133 may receive the tire-road contact acceleration data 809 for a predetermined duration of time or continuously while the motor vehicle 100 is being driven. Accordingly, the duration of time can include multiple revolutions of the tire 103, and the accelerometer 109 may only capture the tire-road contact acceleration data during periods of time the tread 212 extending along the circular arc 127 of the tire 103 contacts the surface 127 as can be appreciated.

In such a case where the accelerometer 109 is configured to only capture the tire-road contact acceleration data 809 during periods of time the tread 212 extending along the circular arc 127 of the tire 103 contacts the surface 127, the accelerometer 109 may begin collecting the tire-road contact acceleration data 809 based on when the radii 121 enters the contact patch 160 region, and end collecting the tire-road contact acceleration data 809 when the radii 121 exits the contact patch 160 region of the tire 103 for one tire revolution. As the radii 121 enters the contact patch 160 region again during the next tire revolution, the accelerometer 109 can be configured to start collecting the tire-road contact acceleration data 809 again and end when the radii 121 exits the contact patch 160 region. This iterative step may be repeated for a predetermined duration of time or continuously until manually stopped. Accordingly, the tire-road contact acceleration data 809 includes data for multiple revolution data sets for the tires 103 and/or 103A.

In box 906, the computing devices 130 and 133 can be configured to receive the velocity data 815 of the tires 103 and/or 103A. The velocity data 815 can include an angular velocity ω of the tires 103 and/or 103A received during movement of the vehicle 100. In some embodiments, the velocity data 815 can also include a linear velocity of the vehicle 100, such as instantaneous velocity as measured by a speedometer during movement of the vehicle 100, or velocity data measured by sensors in the tires 103 or 103A, or by using alternative sensors such as a GPS sensor.

In box 909, the computing devices 130 and 133 can be configured to receive the load data 812 from a load cell connected to the tires 103 and/or 103A, strain gages connected to a suspension system of the vehicle 100, sensors in the tire 103 or 103A, or through other load measuring means as can be appreciated. In some cases, the load data 812 may be extracted from the data measured by the accelerometer 109. The load data 812 includes vertical or normal load data of the motor vehicle 100 acting on the center of the tires 103 or 103A while the vehicle 100 is being driven, such as the vertical load 215. Accordingly, the normal or vertical load 215 may be dynamic. Collectively, the tire-road contact acceleration data 809 received at step 903, the velocity data received at step 906, and the normal load data received at step 909 can comprise dynamic tire data as described herein.

In box 912, the computing devices 130 and 133 can be configured to process the tire-road contact acceleration data 809, the velocity data 815, and the load data 812. For example, at box 912, the computing devices 130 and 133 can be configured to chop the dynamic tire data into a number of per-revolution data subsets to enable the control system 806 to identify relevant information in each per-revolution data subset for predicting the mean vibration characteristic 818 at the center of the tires 103 or 103a. In that case, each per-revolution data subset among the plurality of per-revolution data subsets includes dynamic tire data for one revolution of the tires 103 or 103A. The process at box 912 can also include removing outlier data from the per-revolution data subsets.

In box 915, the computing devices 130 and 133 can be configured to generate the mean vibration characteristic 818 at the center of the tires 103 or 103A. In various embodiments, generating the mean vibration characteristic 818 includes predicting the mean vibration characteristic 818. In processing the above-mentioned dynamic tire data to predict the mean vibration characteristic 818, the control system 806 can use various data processing models and/or machine learning algorithms to efficiently predict the mean vibration characteristic 818.

For example, the above-mentioned data that the computing devices 130 and 133 receive can be accessed by using either the time-domain representation or the frequency-domain spectral content. In one embodiment, the frequency-domain spectral content can be used to decompose the time-varying signals into their frequency composition. Further, Welch's periodogram method can be used to access the spectral domain information, and the output of this analysis can be displayed as a power spectrum of individual tire revolutions in some cases.

Predicting the mean vibration characteristic 818 can further involve applying a machine learning algorithm to the tire-road contact acceleration data 809, the load data 812, and the velocity data 815. With the above-mentioned data selected as inputs to the machine learning algorithm, the output can return the mean vibration characteristic 818 for one or more tire revolutions. The machine learning algorithms can include use of a decision tree, bootstrapped aggregation, and/or a neural network. Thus, the predicted mean vibration characteristic 818 is dynamically affected by the tire-road contact acceleration data 809, the load data 812, and the velocity data 815. In some embodiments, the above-mentioned data may be inputted into a vibration modeler, which can predict the mean vibration characteristic 818.

After box 915, the control system 806 may go directly to box 927 in some cases to adjust a stiffness of the spokes 203 according to some embodiments. In one example, the predicted mean vibration characteristic 818 can be compared against a defined ride comfort matrix, and if the predicted mean vibration characteristic 818 is higher than the maximum limit on this comfort matrix, the computing devices 130 and/or 133 can reduce the stiffness of the spokes 203 to dampen the vibrations. Alternatively, if the predicted mean vibration characteristic 818 is lower than the minimum limit of the comfort matrix, the computing devices 130 and/or 133 can increase the stiffness of the spokes 203.

In this respect, the spokes 203 can include smart material that can adjust its properties in real time based on an external stimuli, such as magnetic fields, temperature, pressure, electrical impulses, and other external stimuli, based on the predicted mean vibration characteristic 818. Accordingly, the spokes 203 can include piezoelectric material, shape memory materials, chromoactive materials, magnetorheological materials, photoactive materials, and other types of smart materials. Thereafter, the portion of the control system 806 may end.

In other embodiments, after box 915, the control system may move to box 918. In box 918, the control system 806 may generate a transfer function or a frequency response function based on the tire-road contact acceleration data 809, the load data 812, and the velocity data 815 as inputs and the mean vibration characteristic 818 as the output of the transfer function. Further transfer functions can be created based on a particular spoke design and material stiffness of the tires 103 and 103A, in which the generated transfer function can be used for the selection of specific smart material to be used as the spoke 203 material.

Moving on to boxes 921 and 924, the control system 806 can verify the predicted mean vibration characteristic 818 for the tires 103 and 103A based on the tire center acceleration data 821 measured by the accelerometer 303 (FIG. 3). According to various embodiments, the accelerometer 303 can be configured to measure acceleration at the center of the tire 103 during periods the tread 212 that extends along an outer periphery of the circular arc 124 contacts the surface 127. In this case, the accelerometer 303 can be configured to transmit data to the computing devices 130 and/or 133 synchronously with the accelerometer 109. In some cases, the accelerometer 303 may transmit the tire-center acceleration data 821 to the computing devices 130 and/or 133 continuously.

In order to accurately measure vertical acceleration (z-axis), longitudinal acceleration (x-axis), and lateral acceleration (y-axis) at the center of the tire 103, the accelerometer 303 may be vertically aligned with the accelerometer 109. Accordingly, the data that is retrieved from the accelerometer 303 during periods of time the tread 212 that extends along an outer periphery of the circular arc 124 contacts the surface 127 represents vertical vibrations, or roughness of the ride, transmitted from the contact patch 160 to the center of the tire 103, or to the hub 106 of the vehicle 100.

The control system 806 can compare the predicted mean vibration characteristic 818 with the tire-center acceleration data 821 to determine the accuracy of the predicted mean vibration characteristic 818. If it is determined that the predicted mean vibration characteristic 818 is accurate, the control system 806 may adjust the stiffness of the spokes 203 in some cases to improve the ride comfort if deemed necessary, as outlined for box 927 above. If not deemed accurate, the computing devices 130 and/or 133 may continue to process the tire-road contact acceleration data 809, the load data 812, and the velocity data 815, for more per-revolution data sets until an accurate mean vibration characteristic 818 is predicted. However, in some embodiments, the computing devices 130 and/or 133 may adjust the stiffness of the spokes 203 based on the predicted mean vibration characteristic 818 regardless of the comparison with the tire-center acceleration data 821. Thereafter, the portion of the control system 806 may end.

It is understood that there may be other applications that are stored in the memory 803 and are executable by the processor 800 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 803 and are executable by the processor 800. In this respect, the term “executable” means a program file that is in a form that can ultimately be run by the processor 800. Examples of executable programs may be, for example, a compiled program that can be translated into machine code in a format that can be loaded into a random access portion of the memory 803 and run by the processor 800, source code that may be expressed in proper format such as object code that is capable of being loaded into a random access portion of the memory 803 and executed by the processor 800, or source code that may be interpreted by another executable program to generate instructions in a random access portion of the memory 803 to be executed by the processor 800, etc. An executable program may be stored in any portion or component of the memory 803 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 803 is defined herein as including both volatile and nonvolatile memory and data storage components. Volatile components are those that do not retain data values upon loss of power. Nonvolatile components are those that retain data upon a loss of power. Thus, the memory 803 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 800 may represent multiple processors 800 and/or multiple processor cores and the memory 803 may represent multiple memories 803 that operate in parallel processing circuits, respectively. In such a case, the local interface 824 may be an appropriate network that facilitates communication between any two of the multiple processors 800, between any processor 800 and any of the memories 803, or between any two of the memories 803, etc.

The flowchart of FIG. 9 shows the functionality and operation of an implementation of portions of the control system 806. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the processor 800 in a computer system or other system. The machine code may be converted from the source code, etc. If embodied in hardware, each block may represent a circuit or a number of interconnected circuits to implement the specified logical function(s).

Although the flowchart of FIG. 9 shows a specific order of execution, it is understood that the order of execution may differ from that which is depicted. For example, the order of execution of two or more blocks may be scrambled relative to the order shown. Also, two or more blocks shown in succession in FIG. 9 may be executed concurrently or with partial concurrence. Further, in some embodiments, one or more of the blocks shown in FIG. 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the control system 806, that comprises software or code can be embodied in any non-transitory computer-readable medium for use by or in connection with an instruction execution system such as, for example, the processor 800 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the control system 806, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing devices 130 and 133 or in multiple computing devices. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method for measuring a vibration characteristic of a non-pneumatic tire, comprising:
receiving, by a computing device, tire-road contact acceleration data from an accelerometer, the accelerometer being secured to a spoke of a non-pneumatic tire within a sector of the tire, wherein the tire-road contact acceleration data comprises acceleration data captured by the accelerometer over a duration of time while a tread extending along an outer periphery of the sector of the tire contacts a surface;
receiving, by the computing device, velocity data for the tire over the duration of time;
receiving, by the computing device, normal load data for the tire over the duration of time; and
generating, by the computing device, a mean vibration characteristic for the tire based on the tire-road contact acceleration data, the velocity data, and the normal load data.

2. The method of claim 1, further comprising generating a transfer function or a frequency response function for the tire based on the mean vibration characteristic for the tire.

3. The method of claim 1, wherein:
the normal load data, the velocity data, and the tire-road contact acceleration data comprise dynamic tire data; and
the method further comprises chopping the dynamic tire data into a plurality of per-revolution data subsets, a per-revolution data subset among the plurality of per-revolution data subsets comprising dynamic tire data for one revolution of the tire.

4. The method of claim 3, further comprising removing outlier data from the plurality of per-revolution data subsets.

5. The method of claim 4, further comprising feeding the plurality of per-revolution data subsets into a vibration modeler for generating the mean vibration characteristic for the tire.

6. The method of claim 1, wherein the tire comprises a second accelerometer secured within the tire at a location closer to a center of the tire than to the accelerometer, the second accelerometer being communicatively coupled to the computing device and configured to transmit tire-center acceleration data to the computing device over the duration of time while the tread extending along the outer periphery of the sector contacts the surface.

7. The method of claim 6, further comprising comparing the mean vibration characteristic for the tire to the tire-center acceleration data.

8. The method of claim 1, wherein generating the mean vibration characteristic for the tire comprises applying a machine learning algorithm to the tire-road contact acceleration data, the velocity data, and the normal load data.

9. The method of claim 8, wherein the machine learning algorithm comprises a decision tree and bootstrapped aggregation.

10. The method of claim 8, wherein the machine learning algorithm comprises a neural network.

11. The method of claim 1, wherein generating the mean vibration characteristic for the tire comprises performing a frequency domain analysis on the tire-road contact acceleration data, the velocity data, and the normal load data.

12. The method of claim 1, wherein the tire comprises a plurality of spokes, the plurality of spokes comprising smart material, the smart material configured to change in stiffness based on an external stimuli.

13. The method of claim 12, wherein the smart material comprises piezoelectric material.

14. The method of claim 12, wherein the method further comprises changing a stiffness of the plurality of spokes based on the mean vibration characteristic for the tire.

15. The method of claim 1, wherein the sector comprises an area enclosed by a region of the tire defined between a contact patch angle having a vertex at a center of the tire, radii extending from the contact patch angle to a circular arc extending along the outer periphery of the tire between the radii, and the circular arc.

16. The method of claim 15, wherein the accelerometer is secured to the spoke at a position closer to the circular arc than to the center of the tire.

17. The method of claim 15, wherein the mean vibration characteristic for the tire comprises an average vibration characteristic estimated at the center of the tire, and the tire-road contact acceleration data comprises vibration characteristics measured while the tread along the outer periphery of the sector of the tire contacts the surface.

18. A smart non-pneumatic tire, comprising:
an accelerometer, the accelerometer being secured to a spoke of the non-pneumatic tire within a sector of the tire; and
a computing device communicatively coupled to the accelerometer, the computing device configured to:
receive tire-road contact acceleration data from the accelerometer, wherein the tire-road contact acceleration data comprises acceleration data captured by the accelerometer over a duration of time while a tread extending along an outer periphery of the sector of the tire contacts a surface;
receive velocity data for the tire over the duration of time;
receive normal load data for the tire over the duration of time; and
generate a mean vibration characteristic for the tire based on the tire-road contact acceleration data, the velocity data, and the normal load data.

19. The smart non-pneumatic tire of claim 18, wherein the sector comprises an area enclosed by a region of the tire defined between a contact patch angle having a vertex at a center of the tire, radii extending from the contact patch angle to a circular arc extending along the outer periphery of the tire between the radii, and the circular arc.

20. The smart non-pneumatic tire of claim 18, wherein the tire comprises a plurality of spokes, the plurality of spokes comprising smart material, the smart material configured to change in stiffness based on an external stimuli.
